(19) United States
(12) Patent Application Publication
(10) Pub. No.: US 2011/0298907 A1
(43) Pub. Date: Dec. 8, 2011

(54) Device for Identifying Specific Tire Type

(75) Inventor: Ki Seong LEE, Daejeon (KR)

(73) Assignee: NES&TEC Co., Ltd., Daejeon (KR)

(21) Appl. No.: 12/953,579

(22) Filed: Nov. 24, 2010

(30) Foreign Application Priority Data
Jun. 8, 2010 (KR) 10-2010-0053630
Jun. 25, 2010 (KR) 10-2010-0060272

(51) Int. Cl. H04N 7/18

(52) U.S. Cl. 348/61; 348/E07.085

(57) ABSTRACT

The present invention relates to a device for identifying the type of tire by measuring the size and shape of the tire with a 3D scanner. A tire identification device according to the present invention is connected with a 3D scanner and a user terminal, and includes a tire standard database storing 3D scan data of a plurality of tires and an identification module searching 3D scan data having a pattern that is the same as a pattern of 3D scan data transmitted from the 3D scanner in the tire standard database, and providing the type of tire corresponding to the searched 3D scan data. 3D scan data is one of a data cloud and line profile data represented by a bending shape of a side end of a tire. The tier identification device according to the present invention can promptly identify the type of tire without stopping a conveyer in a tire manufacturing process, and the identification is not interrupted by air vent so that the identification rate can be improved.

### CROSS-REFERENCE TO RELATED APPLICATION

This application claims priority to and the benefit of Korean Patent Application Nos. 10-2010-0053630 and 10-2010-0060272 filed in the Korean Intellectual Property Office on Jun. 8, 2010 and Jun. 25, 2010, the entire contents of which are incorporated herein by reference.

### BACKGROUND OF THE INVENTION

(a) Field of the Invention

The present invention relates to a device for identifying the type of a tire by measuring the size and shape of the tire using a 3D scanner.

(b) Description of the Related Art

FIG. 1 schematically shows a conventional tier identification device.

In FIG. 1, a conventional tire identification system identifies the type of tire by comparing a stored tire size list with an outer diameter (OD) of a tire being transferred to a conveyor 30 and an inner diameter (ID) of a wheel portion of the tire measured by a laser sensor 20 moving along an LM guide 10. FIG. 2 shows outer diameters OD and inner diameters ID measured by the conventional identification device.

However, according to the convention method, the laser sensor 20 consumes 10 minutes to move along the LM guide 10 such that the speed of a manufacturing process is delayed, and when the moving speed of the laser sensor 20 is increased, accuracy in the measurement is proportionally decreased.

In addition, the outer diameter OD or the inner diameter ID of the tire may be erroneously measured due to air vent of the tire, thereby deteriorating identification rate.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a tire identification device that can identify the type of tire within a short period of time with a low identification failure rate.

A tire identification device according to an exemplary embodiment of the present invention is connected with a 3D scanner and a user terminal, and includes a tire standard database storing 3D scan data of a plurality of tires and an identification module searching 3D scan data having a pattern that is the same as a pattern of 3D scan data transmitted from the 3D scanner in the tire standard database, and providing the type of tire corresponding to the searched 3D scan data.

The 3D scanner generates 3D scan data by instantaneously scanning a tire being transferred on a conveyor belt.

The tire identification device according to the exemplary embodiment may further include a scan module calculating at least one of an outer diameter, an inner diameter, and the height of a measured tire using the 3D scan data and a secondary identification module secondarily comparing the outer diameter, the inner diameter, and the height of the measured tire with the most closely matching type of tire as a result of the 3D scan data pattern comparison of the identification module.

The secondary identification module can perform the secondary comparison when a difference between 3D scan data of the most closely matching type of tire and 3D scan data of a scanned tire is not included with a predetermined error range as a result of the 3D scan data pattern comparison of the identification module.

The tier identification device according to the present invention can promptly identify the type of tire without stopping a conveyer in a tire manufacturing process, and the identification is not interrupted by air vent so that the identification rate can be improved.

### BRIEF DESCRIPTION OF THE DRAWINGS

FIG. 1 schematically shows a conventional tire identifying method.

FIG. 2 shows values measured by a conventional identification device.

FIG. 3 shows a tire identification system according to an exemplary embodiment of the present invention.

FIG. 4 schematically shows an approximate mounting position of a 3D scanner.

FIG. 5 shows main values of the tire, measured by the 3D scanner, and FIG. 6 exemplarily shows a data cloud generated from the tire measurement of FIG. 6.

FIG. 7 and FIG. 10 show identification servers according to respective exemplary embodiments.

FIG. 8 exemplarily shows three types of side shapes of the tire and FIG. 9 shows the bending shapes of the sides of the respective tires of FIG. 8.

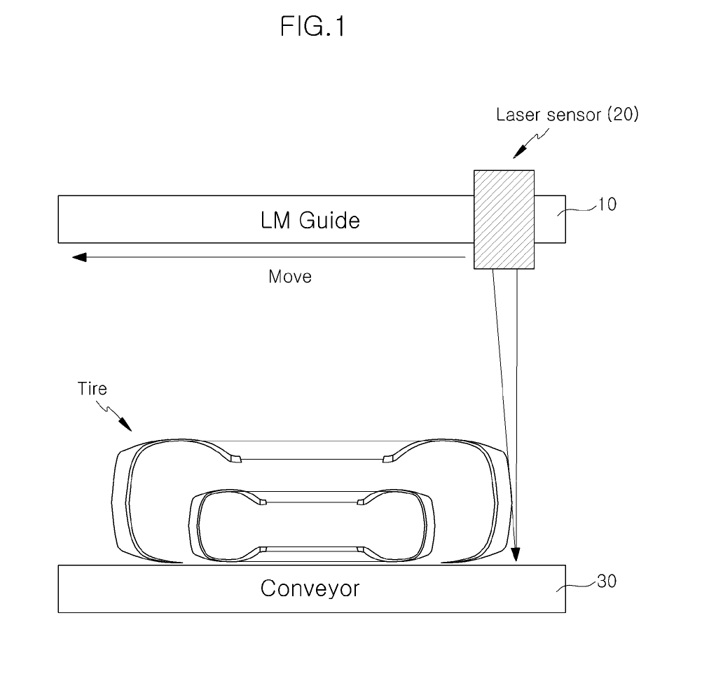

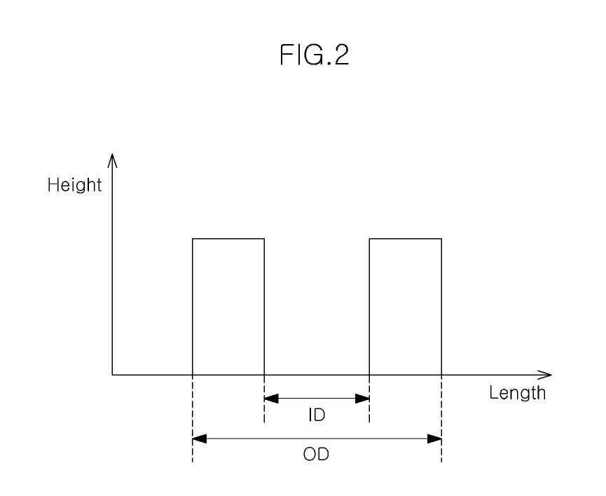

### DETAILED DESCRIPTION OF THE EMBODIMENTS

The present invention will be described more fully hereinafter with reference to the accompanying drawings, in which exemplary embodiments of the present invention are shown. The drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In the specification, a tire identification device is the same as an identification server included in a tire identification system.

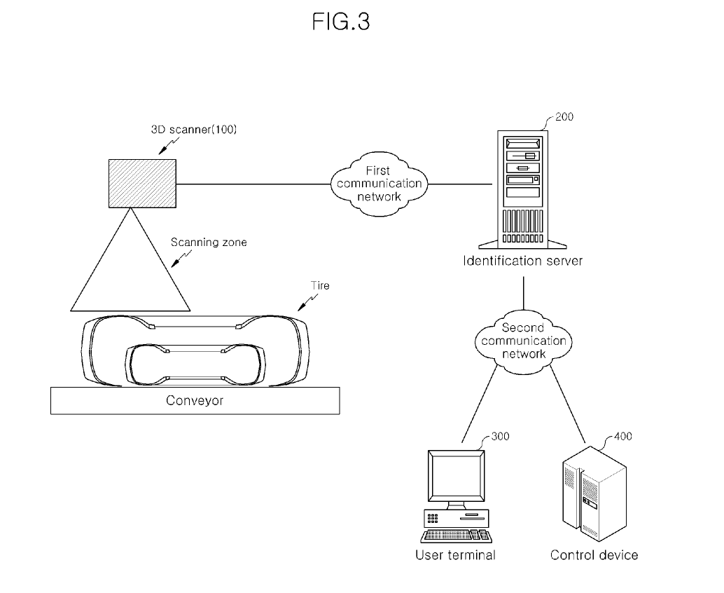

FIG. 3 shows a configuration of a tire identification system according to an exemplary embodiment of the present invention. In FIG. 3, the tire identification system includes a 3D scanner 100, an identification server 200 connected with the 3D scanner 100 through a predetermined first communication network, and a user terminal 300 and/or a control device 400 connected with the identification server 200 through a predetermined second communication network.

The 3D scanner 100 is called a laser scanner or ground-based light detection and ranging (lidar), and calculates two-way travel time of a laser beam transmitted to a measurement object and reflected therefrom or a phase difference. The 3D scanner 100 represents the calculated two-way travel time or the phase difference with 3D coordinate components (or, points) of X, Y, and Z in point clouds where points are grouped.

A 3D scanner 100 according to the other example recognizes a surface bending shape of an object to be scanned using a 3D laser profile sensor (or, 3D high profile sensor) formed of a line laser and a digital camera. The 3D laser profile sensor, for example, can acquire line profile data of the object to be scanned in 25 KHz/sec so that it can instantaneously scan a tire being transferred with accuracy.

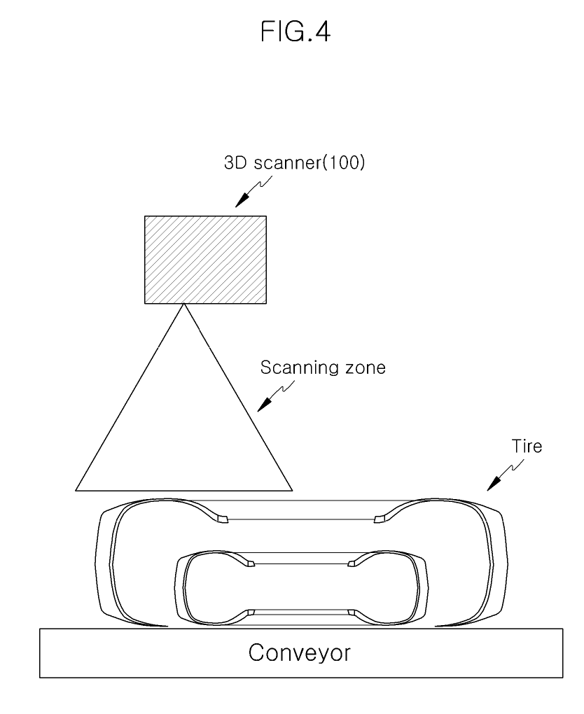

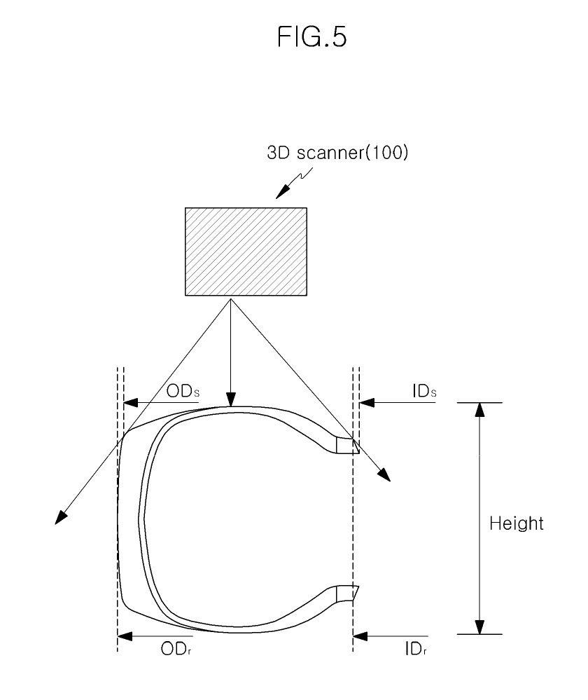

FIG. 4 schematically shows a mounting location of the 3D scanner 100.

The 3D scanner 100 is preferably installed at a position perpendicularly separated by a predetermined height from a position separated to the outside by a predetermined distance from a central shaft of the tire to measure a side wall of one side of the tire. Alternatively, as shown in the example of FIG. 4, when the 3D scanner 100 scans a tire loaded on a conveyor and being transferred, the 3D scanner is preferably installed at a position separated by a predetermined height from a location separated to the left or the right by a predetermined distance from a central shaft of a conveyor belt transferring direction. However, the installation location of the 3D scanner 100 can be changed depending on the pose (e.g., a case of being perpendicularly disposed) or a transferring form (e.g., a case of being perpendicularly transferred) of a tire to be measured, and therefore, it is not restrictive.

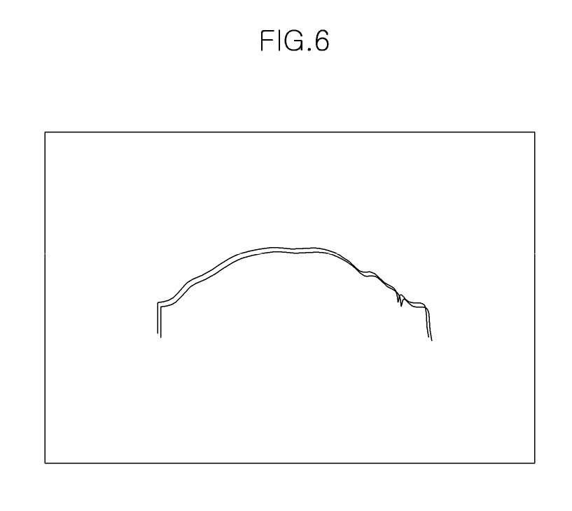

FIG. 5 shows main values of the tire, measured by the 3D scanner 100 and FIG. 6 exemplary shows a data cloud generated from the measurement of the tire of FIG. 5. Hereinafter, a point cloud or line profile data acquired by scanning a side wall portion of the tire will be referred to a side bending shape.

The 3D scanner 100 generates the side bending shape by photographing the side wall portion of the tire as shown in FIG. 6. Referring to FIG. 6 with reference to FIG. 5, an outer diameter ODₛ and an inner diameter IDₛ measured by the 3D scanner 100 may be inaccurate due to a measurement angle of an actual outer diameter ODᵣ and an actual inner diameter IDᵣ. That is, the measured outer diameter ODₛ is smaller than the actual outer diameter ODᵣ, and the measured inner diameter IDₛ is larger than the actual inner diameter IDᵣ. Thus, a deviation may occur in the side bending shape of FIG. 6 compared to an actual side bending shape, but a side bending shape of a comparison object registered in a tire size data base also includes such a deviation, and therefore tire identification can be accurately performed.

The 3D scanner 100 performs 3D photographing on a tire being transferred through a conveyor belt or being stopped by control of the identification server 200. For automatic photographing of the tire being transferred, the tire identifying system according to the exemplary embodiment of the present invention may further include a line sensor (not shown) for determining whether the tire being transferred enters a photographing zone.

The line sensor senses whether the tire is entered by emitting a laser or a infrared ray, and gives scanning instructions to the 3D scanner 100 or transmits the scanning instructions via the identification server 200 when the entering of the tire is sensed. The 3D scanner 100 is being waited in a power-on state or a scan ready state by “scan start instructions” so that it can perform instantaneous 3D scanning by “scanning instructions”.

The user terminal 300 is a client formed of an input unit (not shown) for inputting various operation instructions to the identification server 200, an output unit (not shown) for outputting a performance result according to the operation instructions, and a data communication unit (not shown) for data exchange with the identification server 200 through the second communication network. The input unit receives various operation instructions to be transmitted to the identification server 200 using input means such as a keyboard, a touch screen, a mouse, and voice recognition. The output unit outputs a performance result according to the operation instructions through at least one of a monitor, a printer, and a speaker. The data communication unit supports the same communication protocol that the identification server 200 supports for communication with the user terminal 300. Selectively, the user terminal 300 may further include a memory (not shown) for storing a user application program for controlling start, operation, and termination of the 3D scanner 100 and/or a user application program for controlling start, setting modification, and terminal of the identification server 200 and a central processing unit (CPU, not shown) for performing the user application programs.

The control device 400 refers to a programmable logic controller (PLC), a distributed control system (DCS), or a PC-human machine interface (PC-HMI) for control, and is provided with a data communication unit (not shown) for communication with the identification server 200 through the second communication network. Various actuators, conveyors, and a packing device connected to the control device 400 can be controlled using the same.

Hereinafter, tire identification operation of the identification server 200 will be described in further detail with respective exemplary embodiments.

### Exemplary Embodiment 1

The exemplary embodiment 1 relates to a method for measuring a side bending shape of a tire to determine the type of tire by comparing the measured side bending shape with bending shapes stored in a tire standard database.

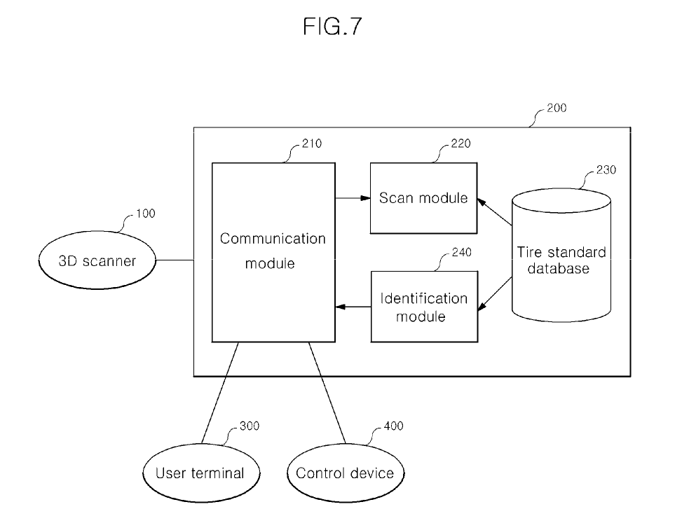

FIG. 7 shows a configuration of an identification server 200 according to the exemplary embodiment 1. In FIG. 7, the identification server 200 includes a communication module 210, a scan module 220, a tire standard database 230, and an identification module 240.

The communication module 210 supports at least one of a wired serial communication protocol such as USB or RS-232C, a near field communication protocol such as Bluetooth, Infrared ray communication (IrDA), and ZigBee, and Internet communication protocols such as TCP/IP, HTTP, and FTP to exchange data with a 3D scanner 100 through a first communication network. For example, when the communication module 210 communicates with the 3D scanner 100 using the Internet communication protocol, an Ethernet protocol that supports a gigabit speed is preferably satisfied for seamless communication with large scan data capacity.

In addition, the communication module 210 supports the internet communication protocol such as TCP/IP, HTTP, and FTP for data exchange with the user terminal 300 through the second communication network, and may further support at least one of the wired serial communication protocol, the internet communication protocol, and a field bus for communication with various control devices 400 that require information on the type of tire identified by the identification server 200.

The scan module 220 transmits control instructions such as scan start instructions, scan instructions, and scan stop instructions, and receives scan data (side bending shape) from the 3D scanner 100 and stores the same in a memory (not shown).

The tire standard database 230 pre-stores reference information for tire identification. The reference information includes a bending shape of a specific tire and the bending shape should be stored prior to actual tire identification operation. The standards used in tire manufacturing may be used as the reference information, and the tire standard database 230 may be built by directly scanning all types of tires manufactured from the corresponding plant. A method for building data base using the latter case will now be described.

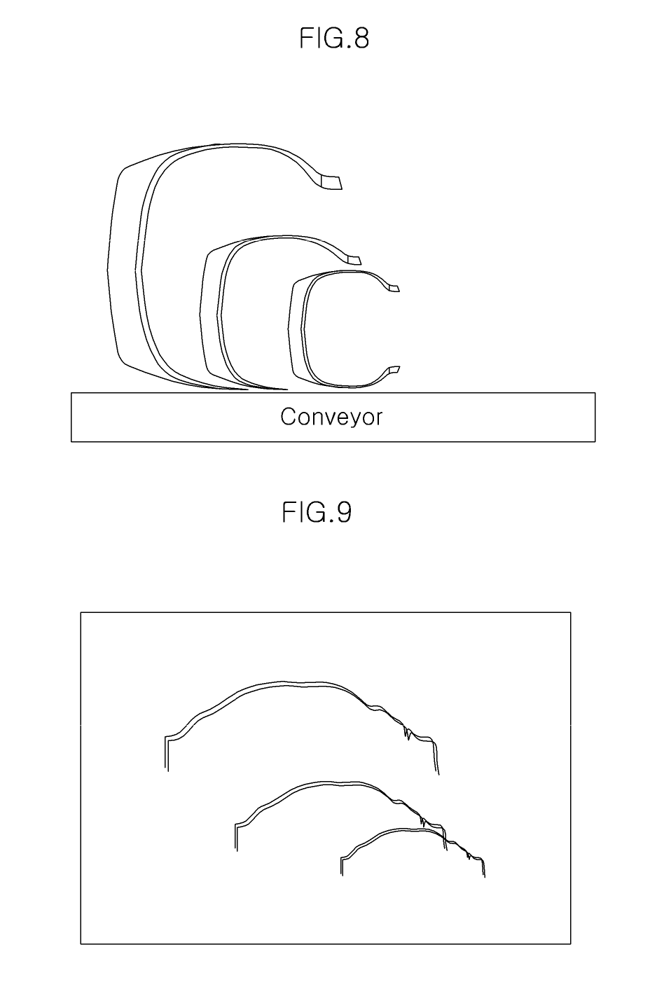

In general, each type of tire has different outer and inner diameters, and a bending shape of a side of the tire is changed due to the difference of the outer diameter and the difference of the inner diameter. FIG. 8 shows side shapes of three different types of tires, and FIG. 9 shows side bending shapes acquired by scanning the tires of FIG. 8.

When bending shapes of FIG. 9 are generated as a result of scanning of all types of to-be-identified tires of the corresponding plant, the generated bending shapes are stored in the tire standard database 230 with a predetermined tire identifier.

After the tire standard database 230 is built, the identification module 240 compares (i.e., pattern matching) a pattern of a side bending shape measured using the 3D scanner 100 with a pattern of a bending shape stored in the tire standard database 230 to determine the type of the corresponding tire.

### Exemplary Embodiment 2

The exemplary embodiment 2 relates to a method for identifying the type of tire by correcting a scan error when a tire is scanned at an inappropriate scanning position and thus identification of the type of tire using pattern matching of side bending shapes is failed.

Since a tire to be measured may not be properly located at a fixed photographing position or may not be located at the center of a conveyor belt, the side bending shape acquired by scanning may not match the bending shape stored in the tire standard database 230. That is, a location-related error may occur between a pattern of the measured bending shape and a pattern of the stored bending shape.

Thus, a tire identifying system according to the exemplary embodiment 2 primarily matches a pattern of a measured bending shape and a pattern of a stored bending shape, and then may secondarily compare whether at least one of an outer diameter OD, an inner diameter ID, and the height Height of the measured bending shape matches an outer diameter OD, an inner diameter ID, and the height Height of the primarily matched stored bending shape within a predetermined error range when tire identification using the primary matching is a failure. As a result of the secondary comparison, a difference between the two values is included within an allowable error range, the measured tire is determined to be the type of tire (or, item) having the primarily matched pattern.

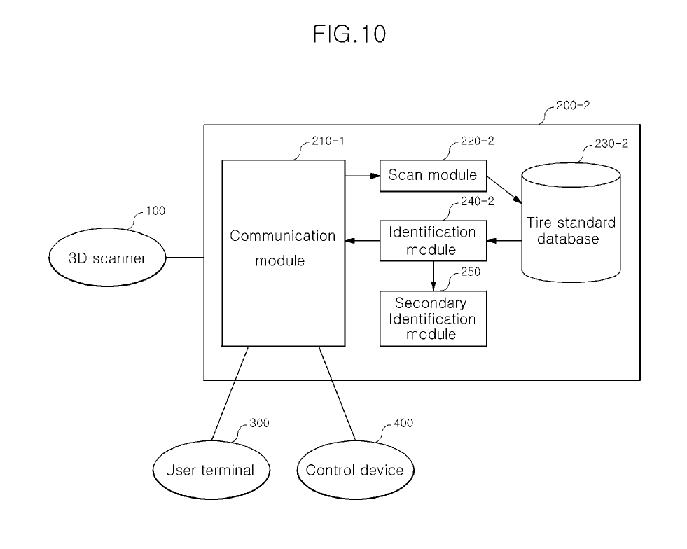

FIG. 10 shows a configuration of an identification server 200-2 according to the exemplary embodiment 2. In FIG. 10, the identification server 200-2 includes a communication module 210-2, a scan module 220-2, a tire standard database 230-2, an identification module 240-2, and a secondary identification module 250. The communication module 210-2 of the exemplary embodiment 2 is the same as the communication module 210-1 of the exemplary embodiment 1, and therefore no further description will be provided.

The scan module 220-2 transmits control instructions such as scan start instructions, scan instructions, and scan stop instructions, and receives scan data (side bending shape) from a 3D scanner 100 and stores the same in a memory (not shown). In addition, the scan module 220-2 calculates at least one of an outer diameter OD, an inner diameter ID, and the height Height of a tire using the scan data (i.e., side bending shape) and stores the same in a memory (not shown).

The tire standard database 230-2 pre-stores reference information for tire identification. The reference information includes at least one of an outer diameter OD, an inner diameter ID, and the height Height of a specific tire and a side bending shape, and should be stored prior to actual tire identification operation.

The identification module 240-2 searches a pattern of a bending shape that is the most similar to a pattern of a bending shape measured by the 3D scanner 100 and performing primary matching.

When an error of the two bending shape patterns is not included in a predetermined error range as a result of the primary matching, the secondary identification module 250 secondarily compares whether at least one of an outer diameter OD, an inner diameter ID, and the height Height of a measured tire matches the outer diameter OD, the inner diameter ID, and the height Height of the primarily matched bending shape within the predetermined error range.

Although the side bending shape is used for tire identification in the above-described exemplary embodiments, a measured plane shape of a tire may be used to identify the type of tire because the data cloud includes not only the side end of the tire but also others.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Further, it is understood that the present invention exemplary embodiments not only limited to a device, but, on the contrary, is intended to be applied to methods and programs for realizing the above-described method.

What is claimed is:

1. A tire identification device connected with a 3D scanner and a user terminal, comprising:
a tire standard database storing 3D scan data of a plurality of tires; and
an identification module searching 3D scan data having a pattern that is the same as a pattern of 3D scan data transmitted from the 3D scanner in the tire standard database, and providing the type of tire corresponding to the searched 3D scan data.

2. The tire identification device of claim 1, wherein the 3D scan data is at least one of a data cloud and line profile data represented by a bending shape of a side end of a tire.

3. The tire identification device of claim 1, wherein the 3D scanner generates 3D scan data by instantaneously scanning at least one of a tire being transferred on a conveyor belt or a tire being stopped.

4. The tire identification device of claim 1, further comprising a scan module calculating at least one of an outer diameter, an inner diameter, and the height of a measured tire using the 3D scan data.

5. The tire identification device of claim 4, wherein the tire standard database further pre-stores at least one of outer diameters, inner diameters, and the heights of the plurality of tires.

6. The tire identification device of claim 5, further comprising a secondary identification module secondarily comparing the outer diameter, the inner diameter, and the height of the measured tire with the most closely matching type of tire as a result of the 3D scan data pattern comparison of the identification module.

7. The tire identification device of claim 6, wherein the secondary identification module performs the secondary comparison when a difference between 3D scan data of the most closely matching type of tire and 3D scan data of a scanned tire is not included with a predetermined error range as a result of the 3D scan data pattern comparison of the identification module.
